(19) United States
(12) Patent Application Publication
(10) Pub. No.: US 2015/0161272 A1
(43) Pub. Date: Jun. 11, 2015

(54) Graphical User Interface With Dynamic Stopwatch For Decedent Management Systems And Methods

(71) Applicant: The Hart Island Project, Inc., Peekskill, NY (US)

(72) Inventors: Bram Broerse, Utrecht (NL); Maurits Olivier Wouters, Utrecht (NL); Vincent de Boer, Utrecht (NL)

(73) Assignee: THE HART ISLAND PROJECT, INC., Peekskill, NY (US)

(21) Appl. No.: 14/565,714

(22) Filed: Dec. 10, 2014

Related U.S. Application Data
(60) Provisional application No. 61/914,257, filed on Dec. 10, 2013.

(51) Int. Cl. G06F 17/30

(52) U.S. Cl. CPC G06F 17/30867

(57) ABSTRACT

A graphical user interface with dynamics stopwatch for decedent management systems and methods are provided herein. More specifically, provided herein is a method of managing decedents comprising electronically receiving at a decedent management computer system a decedent query, electronically searching a database for an electronic decedent record set corresponding to the decedent query and that has a plurality of electronic decedent records, the plurality of electronic decedent records including a plurality of electronic decedent records, each with a decedent burial date and an electronic dynamic stopwatch having a time zero calibrated to the decedent burial date, and electronically transmitting, by the decedent management computer system to the user computer system, the electronic decedent record set for displaying at least a portion thereof with at least one of the electronic dynamic stopwatches shown to be incrementally ascending.

### CROSS-REFERENCED TO RELATED APPLICATION

This application claims the benefit of priority to U.S. Provisional Patent Application No. 61/914,257, filed on Dec. 10, 2013, the contents of which are incorporated herein by reference in their entirety for all purposes.

### FIELD OF THE INVENTION

The present invention relates to decedent management systems and methods having a graphical user interface, such as a search module that electronically produces a search hit set of deceased person record(s) in response to a user search query over a network. For example, in preferred embodiments, the decedent management systems and methods relate to persons who were buried anonymously, missing or otherwise unclaimed and possibly with little other known information beyond names and date of death listed in public records.

### BACKGROUND OF THE INVENTION

The Hart Island Project is an organization that helps people locate deceased persons who were buried anonymously on Hart Island, the public cemetery in New York City. Hart Island is an island just offshore from the Bronx, and it became a potter's field for New York City over a century ago. It is among the largest cemeteries in the United States and presently controlled by the New York City Department of Correction (DOC). Although controlled by the DOC, there are numerous sources of deceased persons for burial at Hart Island. For example, one source might be a hospital, where the body is ultimately buried on Hart Island, because it was unclaimed by family at the hospital. In some cases, the family of the loved one who became deceased may not be immediately aware of the death.

Visitors to Hart Island are often not permitted to go to actual gravesites. The island has an estimated one million burials, and mass burials continue in the present day. The people who were buried are often missing to family and friends. The burials are documented by the DOC in handwritten ledger books.

These burials represent a large number of New Yorkers including people from other jurisdictions who donated their bodies for medical research. Due to the burial process their histories have fallen into obscurity and anonymity which means that a large part of American history has been buried along with them. It is difficult for family-members and friends to identify and relocate their relatives. Their stories and the history are significant to the cultural heritage of New York City, the United States and to international peoples whose relatives migrate to the area. The rights of all families of the deceased to visit and commemorate the dead should be preserved as part of common laws inherent to rights to sepulcher in New York State and elsewhere.

In the prior art, this information has been transcribed by the Hart Island Project into an online database of about 66,000 people buried between 1980 and 2011. The records list date of death, date of burial, place of death, name and age, burial permit numbers, burial permit dates, disinterment dates, reburial dates, transfer information, plot numbers, grave numbers within mass burial plots, etc.

In the prior art, the Hart Island Project has an online-searchable database. The database is populated with decedent records, each decent record being associated with an individual person, e.g., a decedent. The decedent record is populated with fourteen potential data fields of listed information where three fields are user searchable. This host computer system is provided with a searchable database, which may be resident at the host, and a user at a user computer system enters a search query based on at least one user searchable field, and a host system receives the search query and processes same using the database. The user searchable fields may include, for example, a decedent name field, a decedent date of death field, a decedent place of death field, and a decedent burial location field (e.g., Plot/Trench number field). The host computer system has a database that includes a plurality of decedent records, each decedent record being for a deceased person, which is referenced herein as a decedent record. Each one of the decedent records can include a decedent death date field, a decedent name field (listed as unknown if the decedent was unidentified), a decedent burial location field (e.g., plot/trench number), a location of death field, and each of these fields of the deceased record correspond to the user searchable fields of the search query that have these names. There can be a first decedent record for a first deceased person and a second decedent record for a second deceased person. The search obtains a decedent record set (e.g., at least one decedent record, but often times a plurality of decedent records) and passes the decedent record set to the user computer system for display thereof to the user in response to the user search query. For example, a first decedent record of the decedent record set includes a first decedent burial date associated with the first decedent burial date field and the first deceased person, a first decedent name associated with the decedent name field and the first deceased person, and a first decedent burial location (e.g., a first trench/plot number) associated with the decedent burial location field, and the first deceased person. As another example, a second decedent record of the decedent record set includes a second decedent burial date associated with the second decedent death date field and the second deceased person, a second decedent name associated with the second decedent name field and second deceased person, and a second decedent burial location (e.g., a second trench/plot number) associated with the second decedent burial location field and the second deceased person.

The prior art system of the Hart Island Project included an on-line SQL database of over sixty thousand public burials dating from 1980-2011 running on a DotNetNuke Windows platform. The database is searchable according to last name, year of death and year of burial. People who donate their bodies to medicine are often buried two years after death, and thus searchable fields can be provided for year of death and/or burial date. The database features other fields that are configurable to be searchable. In the prior art, these fields include burial permit numbers, first names, other names, date of burial permit, place of death, date of disinterment, and party to whom the body was transferred upon disinterment. Hart Island is maintained by the DOC and prison labor is used to perform the daily mass burials. Using the prior art version of the website http://hartisland.net, people could search according to date of death and name.

In the prior art, the graves are listed with plot number, and there is GPS information for the plot numbers.

Notwithstanding the benefits of the prior art, there is a further need to increase awareness and facilitate preserving the histories of the anonymous souls of Hart Island and commemorate their grave locations and dates of internment. Embodiments of the present disclosure may address these and/or other needs to overcome anonymity of populations whose friends and families cannot afford private cemeteries or who were not informed of procedures and cannot visit due to present policies. Embodiments of the present disclosure may additionally or alternatively be presented as an improvement that can be used with any decedent management system, such as those relating to genealogy, for example.

### SUMMARY OF THE INVENTION

Preferred embodiments of the present disclosure provide for an improvement to the graphical user interface of the system and method of decedent management discussed above, as well as others. Embodiments of the present disclosure provide an improvement in the form of an electronic dynamic stopwatch (e.g., dynamic stopwatch) feature of a graphical user interface. The dynamic stopwatch is interchangeably referenced herein as a clock.

In the preferred embodiments of the present disclosure, members (electronic decedent record(s)) of the electronic decedent record set are each associated with a dynamic stopwatch that has an amount of time measured from the decedent's burial date, and which continues incrementing ascendingly until posted digital content has been provided over a network by a user into an electronic profile page associated with the decedent record. In this regard, the decedent record is referenced herein as an “unclaimed decedent record,” and the associated profile page lacks posted digital content (which indicates the decedent has been claimed). In some embodiments, such a profile page would typically include a presentation of the dynamic stopwatch of a graphical user interface with its incremental ascension being shown.

The reference herein to a “claimed decedent record” or “unclaimed decedent record,” and related usage of the words “claimed” and/or “unclaimed,” for example, are a literary allusion to how a next of kin, for example, may “claim” a body of a deceased family member from the mortuary, for example.

In preferred embodiments, where a graphical user interface electronically transmits over a network the decedent record for electronic display as a visual tiling of search results in response to an electronic user search query over a network, a first dynamic stopwatch is electronically displayed in association with the first decedent record and a second dynamic stopwatch is electronically displayed in association with the second decedent record, whereby the first dynamic stopwatch is different than the second dynamic stopwatch. For example, each decedent record returned in response to the user search query may display a different dynamic stopwatch with a different amount of time being shown, as measured from the respective burial dates. This may engender a sense of awe and inspiration upon the user viewing the displayed hit list, and because there may be a high number of unclaimed persons, it translates to this user a sense of appreciation for the lost souls and the magnitude of the mass anonymity associated with a tragic event, such as a mass anonymous burial site visible only as coordinates on a map, such as Hart Island in New York City. It also translates an appreciation for the great passage of time, and the moral call to action to “stop the clock” and give stories to those buried without a “proper” memorial.

In some embodiments of the invention, where the electronic decedent record set includes an electronic decedent record for which the dynamic stopwatch thereof has ceased its incremental ascension, the electronic decedent record is presented in the electronic decedent record set for electronic display over a network without the dynamic stopwatch being shown. In such circumstances, the electronic decedent record is referenced herein as being a claimed electronic decedent record, and the associated profile page has posted digital content (which indicates the decedent has been claimed). In some embodiments, such a profile page would include a presentation of the dynamic stopwatch with its incremental ascension being static (e.g., having ceased counting).

### BRIEF DESCRIPTION OF THE DRAWINGS

For a more complete understanding of the present disclosure, reference is made to the following detailed description of exemplary embodiment(s) considered in conjunction with the accompanying drawings, in which:

FIG. 1 is a network diagram showing a decedent management system that has a database and a presentation engine of the present disclosure and that is in communication via a network with at least one user computer system and a third party content provider system of supplemental decedent management system content;

FIG. 2 is a flow chart showing an exemplary embodiment of a method of the present disclosure in which the decedent management system of FIG. 1 transmits to a user computer system of FIG. 1 a plurality of decedent records having dynamic stopwatches;

FIG. 3 is a screen shot showing an exemplary home page with a randomized decedent record set that includes a plurality of decedent records each having a dynamic stopwatch;

FIG. 4A is a screen shot showing an exemplary search page receiving the decedent name “Grant” into a decedent name field, the search page displaying a decedent record set with decedent records having a dynamic stopwatch that are associated with a decedent having the decedent name “Grant;”

FIG. 4B is a screen shot showing an exemplary search page receiving the decedent name “Grant” into a decedent name field and the decedent year of death “1993” into a decedent year of death field, the search page displaying a decedent record set with decedent records having a dynamic stopwatch that are associated with a decedent having both the decedent name “Grant” and the decedent year of death 1993;

FIG. 5 is a screen shot showing an exemplary profile page of a decedent record of decedent “Laurie Grant” of FIGS. 4A-B, and with a dynamic stopwatch that has ceased its incremental ascension by virtue of entry into the profile page of posted content, such as a link to supplemental content of a third party content provider system;

FIG. 6 is a screen shot showing an exemplary search page receiving the decedent name “Melfi” into a decedent name field, the search page displaying a decedent record set having an unclaimed decedent record with its dynamic stopwatch being shown to be incrementally ascending and with the decedent name “Melfi” inverted;

FIG. 7 is a screen shot showing a top portion of an exemplary profile page, such as that shown in FIG. 5, whereby the profile page is of a decedent record associated with decedent name “Melfi” of FIG. 6, but after posted content, namely, an image file (e.g., a drawing) has been received into the decedent record such that the decedent record had been re-designated from being an unclaimed decedent record to being a claimed decedent record;

FIG. 8 is a screen shot showing an exemplary profile page, such as that shown in FIG. 5 or shown in part in FIG. 7, whereby the profile page is of a decedent record for Vanessa Rodriquez and includes a map button;

FIG. 9 is a screen shot showing a map page callingly invoked by user-selection of the map button of FIG. 8 and provided as supplemental content from the third party content provider system of FIG. 1;

FIG. 10 is a screen shot showing an exemplary home page with a randomized decedent record set that includes a plurality of decedent records each having a dynamic stopwatch; and

FIG. 11 is a screen shot showing another view of the exemplary home page of FIG. 10.

### DETAILED DESCRIPTION OF THE EXEMPLARY EMBODIMENTS

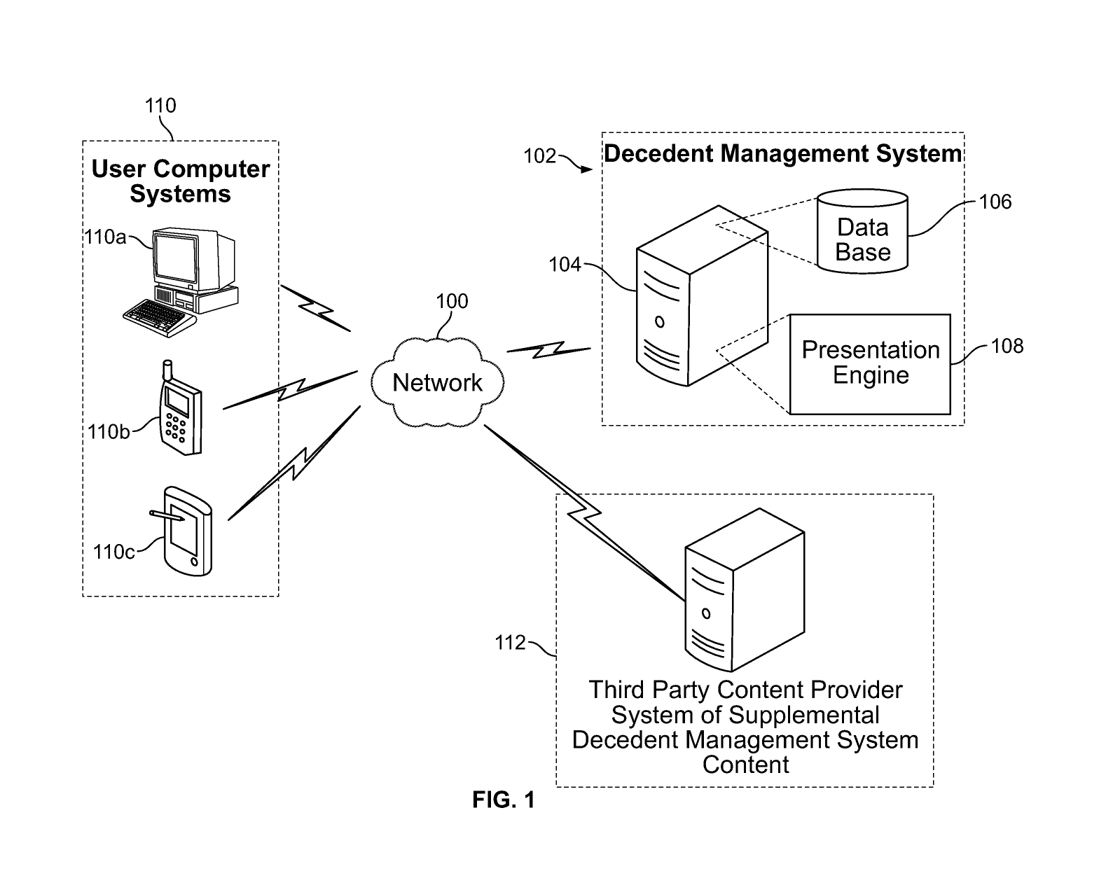

Referring to FIG. 1, a network 100, e.g., the Internet, is provided with a decedent management computer system 102 that has a server 104 hosting a database 106 and a presentation engine 108. The network is provided with a plurality of user computer systems 110, as well as a third party content provider system 112 for providing supplemental content, as described herein.

Decedent management computer system 102 can comprise a general purpose server 104, comprising at least one communications device, a processor, a memory device, and programming suitable for implementing the methods herein described. In an exemplary embodiment, the programming is provided via a database 106 that is a SQL database and a presentation engine electronically delivers over a network decedent records (e.g., electronic decedent records) to a user with electronic dynamic stopwatches associated therewith.

Each user computer system 110 can comprise a general purpose computer, having at least one communications device, a processor, a memory device, a display, and an input device, such as a keyboard, for example. Any user computer system suitable for interfacing with the decedent management computer system 102 is contemplated. For example, the user computer systems 110 can be provided as a desktop (or laptop) computer system 110a, a mobile device computer system 110b, and/or a tablet computer system 110c, for example. The decedent management computer system 102 and the user computer systems 110 are in communication with one another in accordance with any suitable system and/or method known in the art over network 100. In preferred embodiments, the user can be a registered user, and, during registration of the user, geographic information can be collected as part of registration and linked to a world map indicating where stories are coming from.

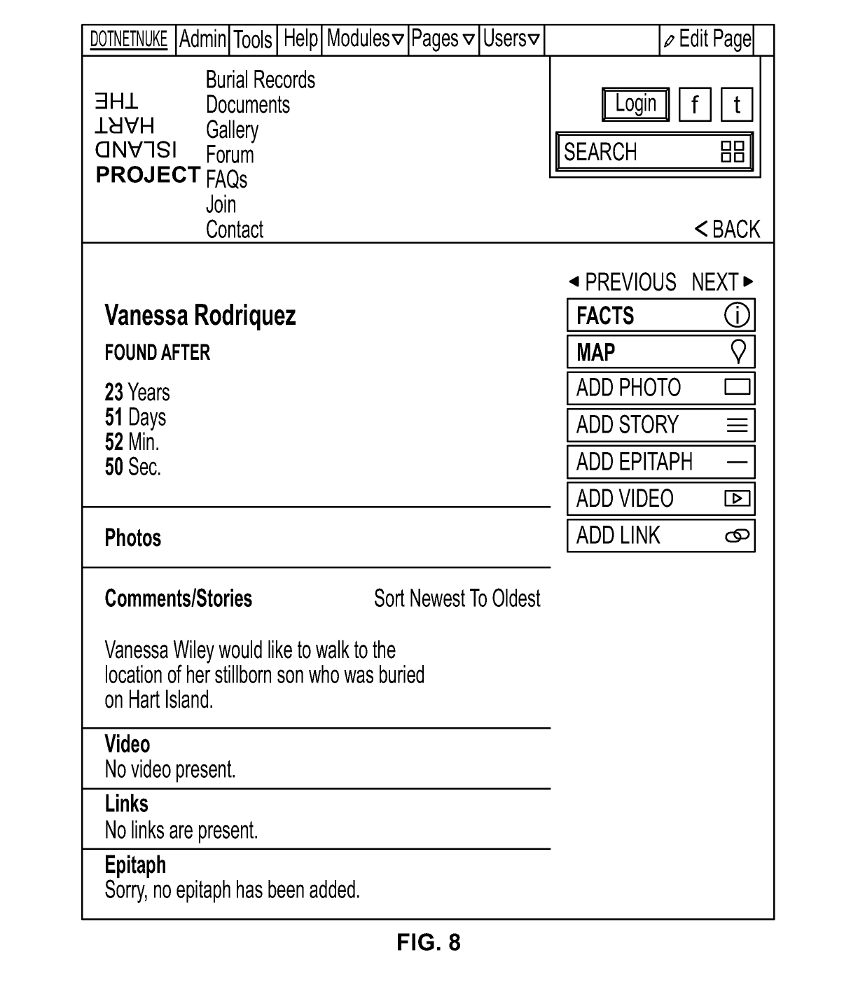

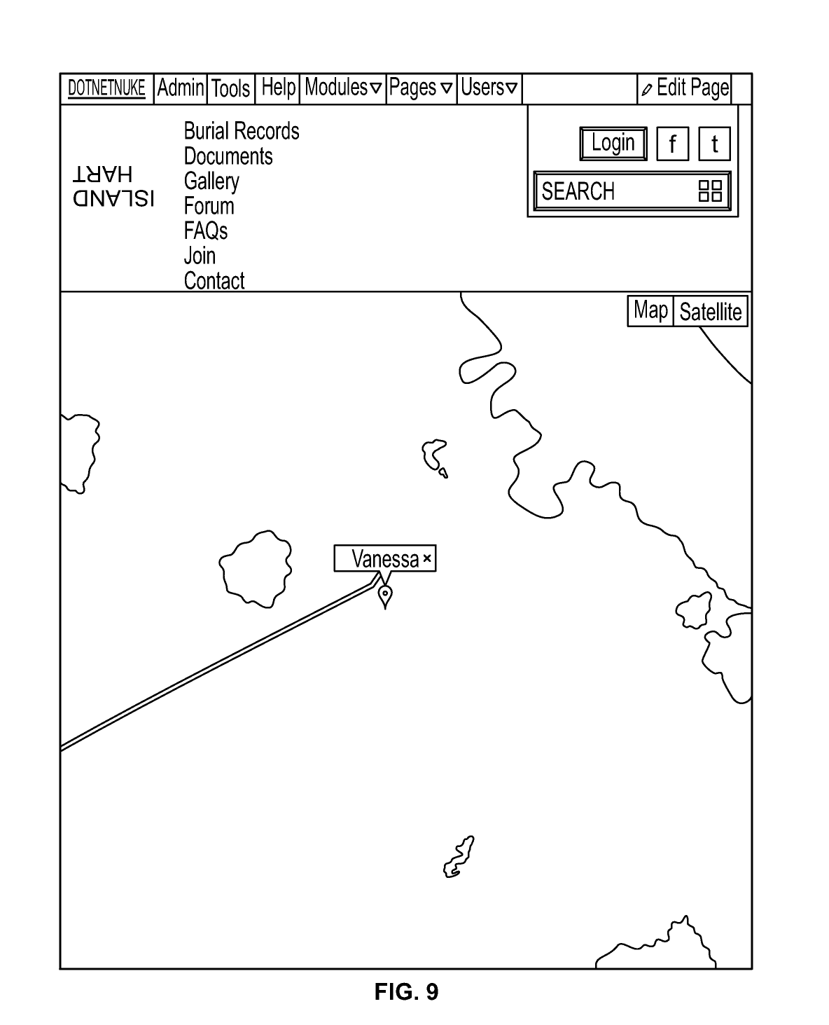

Third party content provider computer system 112 can comprise a general purpose server, having at least one communications device, a processor, a memory device, and programming suitable for implementing the methods herein described. As described herein, the third party provider computer system 112 can provide supplemental content, such as a map or aerial image of a burial location, in association with a decedent record (e.g., electronic decedent record). For example, this may be Google Maps. This is further discussed herein with reference to FIGS. 8 and 9, for example. As another example, a uniform resource locator (URL) link to the third party provider computer system 112 may be associated with the decedent record, such as a URL link to YouTube, for example, such that supplemental content may be associated with the decedent record in the form of a URL link to the third party provider computer system 112. This supplemental content can be an example of posted content, which is discussed further herein.

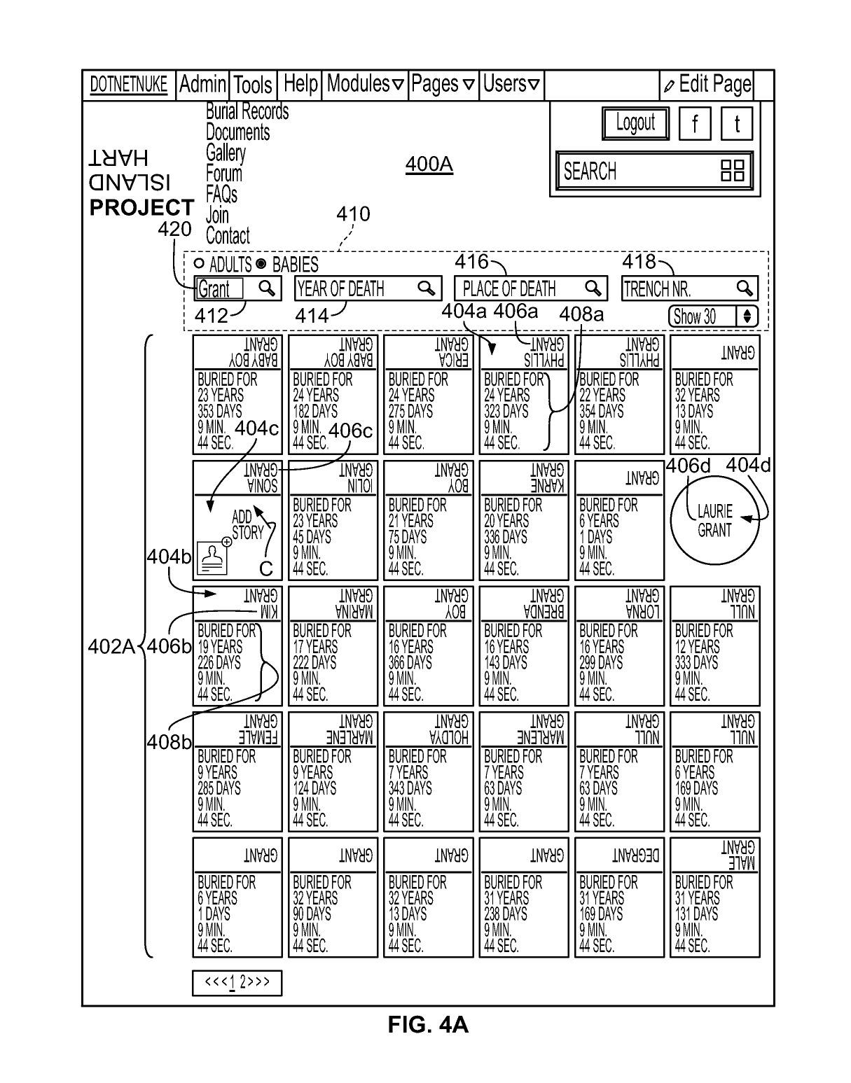

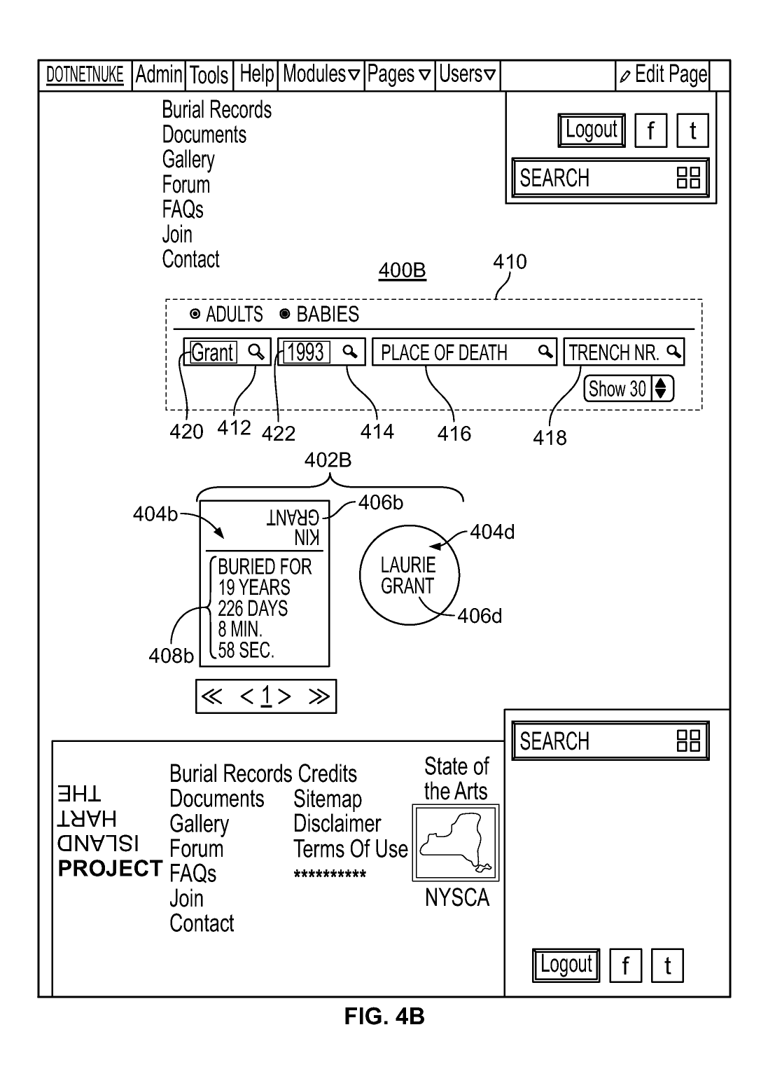

The database 106 may be resident at the decedent management computer system 102, at a computer system in communication therewith, and/or distributed across multiple systems. The user computer system 110 is configured to receive input of a user search query based on at least one searchable field, and the decedent management computer system 110 receives the search query from a user computer system 110 directly and/or indirectly over the network 100. As shall be discussed in connection with example FIG. 4A, for example, a user searchable fields/box 410 may include, for example, a decedent name field 412, a decedent burial date field 414, a decedent place of death field 416, and a decedent burial location field (e.g., trench/plot number field) 418. As shown in FIG. 4A, for example, the user searchable fields/box 410 may also include a field for receiving a user search selection of whether the decedent was an adult or a child, e.g., a baby. The decedent management computer system 102 is provided with the database 106 that includes a plurality of electronic decedent records (e.g., sets of associated data).

Reference herein to the term “decedent name” is typically a reference to the name of the deceased person him/herself. However, where the deceased person has no name, such as may be the case for a deceased baby, reference herein to the “decedent name” may be the name of another person, such as the mother in the example of a deceased baby. For example, there are circumstances where a mother may have delivered a stillborn baby, and, unbeknownst to the mother, her stillborn baby may have passed from the hospital to the DOC, for example, for mass burial in a potter's field. In such circumstances, the decedent name associated with the decedent may be the mother's name, for example. Thus, in some embodiments of the present disclosure, the issue of whether the decedent name references the name of the decedent or alternatively the name of another person (such as the mother of the decedent) is dependent upon the particular decedent record.

In preferred embodiments of the present disclosure, each decedent record is associated with an electronic dynamic stopwatch (e.g., dynamic stopwatch) that is calibrated to a corresponding decedent burial date. This dynamic stopwatch increments ascendingly until suitable digital content (e.g., content) about the decedent has been electronically provided by the public (e.g., a registered user) via the user computer system 110, and this content is referenced herein as posted content (e.g., posted digital content). The posted content may be, for example, photos, videos, stories, epitaphs, etc. The posted content may be in the form of supplemental content from a third party content provider 112, in which case the posted content may take the form of a URL link to the third party content provider system 112, such as YouTube, for example.

In some embodiments of the present disclosure, a minimum level (qualitative and/or quantitative) of posted content can be required in order to “stop the clock,” e.g., cease the incremental ascension of the dynamic stopwatch associated with the decedent record receiving the posted content. In some embodiments of the present disclosure, the electronic receipt by the computer system over the network of any posted content into the decedent record is sufficient to cease the incremental ascension of the dynamic stopwatch associated with the decedent record. As discussed above, where sufficient electronic posted content has been received by the computer system over the network into the profile page of the electronic decedent record to cease the incremental ascension of the dynamic stopwatch associated therewith (e.g., such that the dynamic clock ceases ticking), the corresponding decedent record is referenced herein as a claimed decedent record. As also discussed above, where insufficient posted content has been received into the profile page of the decedent record to cease the incremental ascension of the dynamic stopwatch associated therewith (e.g., such that the dynamic clock keeps ticking), the corresponding decedent record is referenced herein as an unclaimed decedent record.

Continuing with discussion of the database 106 of the decedent management computer system 102, there can be a first decedent record for a first deceased person and a second decedent record for a second deceased person. The database 106 of the identify management computer system 102 transmits a decedent record set (e.g., at least one decedent record, but often a plurality of decedent records) to a presentation engine 108 for communication of the decedent record set and associated dynamic stopwatches to the user computer system 110 via the network 100 for electronic display thereof to the user. For example, a first decedent record of the decedent record set includes a first decedent burial date associated with the first decedent burial date field and the first deceased person, and a first decedent name associated with the first decedent name field and the first deceased person. As another example, a second decedent record of the deceased record set includes a second decedent burial date associated with the second decedent burial date field and the second deceased person, and a second decedent name associated with the second decedent name field and second deceased person.

The presentation engine 108 can associate a dynamic stopwatch with each member of the deceased record set corresponding to the search. For example, a first dynamic stopwatch is associated with a first member (e.g., first decedent record) of the decedent record set, and a second dynamic stopwatch is associated with a second member (e.g., a second decedent record) of the decedent record set. The dynamic stopwatch of the present disclosure increments ascendingly as measured from some beginning point in time, and this beginning point in time is referenced herein for the sake of clarity as “time zero.” As shall be further discussed herein, it is preferable that a first time zero of the first dynamic stopwatch be calibrated to the first decedent burial date and that a second time zero of the second dynamic stopwatch is calibrated to the second decedent burial date. The time zero associated with a decedent can be provided so as to form part of the corresponding decedent record.

It is typical that the burial date of a decedent is known from historical records, but not the exact burial time. For example, in the historical record of the DOC for Hart Island, the historical record includes a burial date for a person buried on Hart Island. Accordingly, whereas the time zero can be calibrated to a burial date (i.e., day) that may be accurate, e.g., from the historical record, it can be more difficult, if even possible at all, to ascertain the exact time of said day from the historical record (e.g., hour, minute, and second, such as 1:14 pm and 24 seconds). Thus, in the present disclosure, a randomizer can be used to digitally associate an hour, minute, and second, with the burial date of a decedent record, such that the time zero associated with the decedent record is calibrated to a year and day and is calibrated (randomly) to an hour, minute and second. Thus, the dynamic stopwatch associated with a decedent name and decedent record therefor can have a time zero (1) that is calibrated at a more general level to a burial date entered into the database from the historical record and (2) that is, in some embodiments, calibrated at a more granular level to a randomized time of day.

Calibrating the time zero at a more granular level than just the day adds to the impact upon the user during presentation of the dynamic stopwatches. For example, by calibrating the time zero at a more granular level, e.g., year, month, day, hour, minute, and second, presentation of the dynamic stopwatches to the user imparts a greater sense of disparity, randomness, and anonymity, for example, when multiple dynamic stopwatches are presented to a user together on a page. Accordingly, when a dynamic stopwatch is one which has ceased incrementing, its impact on a user presents, relatively speaking, a heightened sense of resolution.

Accordingly, while the burial date may often be derived from the historical record, the identify management system 102 can, in some embodiments of the disclosure, set, randomly or otherwise, a time of burial (time of day) to be associated with the burial date, and this random time of day may be considered when the dynamic stopwatch is calibrated to the decedent burial date for assignment of the “time zero.” For example, even where two decedents were buried on the same date, the decedent record associated with a first decedent might have a time zero calibrated to 12:30 p.m. (and twenty seconds) of said burial date, while the other decedent record, i.e., the one for the second decedent, might have a time zero calibrated to 4:22 a.m. (and thirteen seconds) of said same burial date.

To further enhance a feeling of disparity, randomness, and anonymity associated with the incrementally ascending dynamic stopwatches (and the corresponding relative feeling of resolution associated with cessation of the incremental ascension), when electronically displaying multiple dynamic stopwatches, each stopwatch might “tick” (ascend) at different times. For example, a first dynamic stopwatch might tick in one second intervals aligned with an absolute point in time, and a second dynamic stopwatch might tick in one second intervals that are each offset from that same point in time, but offset by seven milliseconds, for example. Analogy can be made to music, in comparing a beat that lands on the “1” of each measure in a series thereof, as compared to a beat that lands on the “3” of each measure in a series thereof.

Each dynamic stopwatch increments ascendingly from time zero until its corresponding stop time. The stop time is a contingency. In preferred embodiments, the stop time occurs at that point in time when the decedent record corresponding to the dynamic stopwatch has electronically received over a network posted content into one of its fields, e.g., the point where the decedent record has transitioned from being an unclaimed decedent record to being a claimed decedent record, which is the point where member(s) of the public have posted content into the associated profile page (thereby imbuing story, personality, or characteristics to the public memory of the deceased, so as to quash the silence or anonymity of personality). Regarding the terminology “claimed decedent record” and “unclaimed decedent record,” a literary allusion is being made to the way in which one “claims” the corporal body of a deceased from a hospital, for example. For example, when a user enters a narrative story, an image, or a link to a YouTube video, the dynamic stopwatch ceases its incremental ascension, the stop time is fixed, and the corresponding decedent record, previously designated by the system 102 as an unclaimed decedent record, is re-designated by the system 102 as a claimed decedent record.

Continuing with an example, if and when the decedent has been sufficiently identified by family and/or another user of a user computer system 110 (so as to be considered to be of a claimed decedent record), e.g., if a user has entered posted content, the dynamic stopwatch ceases its incremental ascension. This time of cessation of the incremental ascension is referenced herein as the stop time. There is an amount of time between time zero and the stop time (i.e., a “delta”), which for the sake of clarity, is referenced herein as a total time unclaimed. In preferred embodiments of the present disclosure, if there is a stop time, the stop time is preferably equal to the total time unclaimed.

If there has been no stop time for a dynamic stopwatch associated with a decedent record, e.g., if the dynamic stopwatch has not ceased its incremental ascension, then the time unclaimed is referenced herein as a dynamic time unclaimed.

Accordingly, it is seen that, in preferred embodiments of the present disclosure, each dynamic stopwatch has a time zero calibrated to a corresponding decedent burial date. Thus, in accordance with some embodiments of the present disclosure, each one of a plurality of decedent records of a decedent record set are electronically associated (e.g., via a database structure) with a corresponding one of a plurality of dynamic stopwatches, and when the decedent record set is presented for display to a user, the graphical user interface includes a presentation for display of the multiple dynamic stopwatches. Considering with this example embodiment, the dynamic stopwatches of the unclaimed decedent records are electronically displayed (e.g., as part of the graphical user interface) to be incrementally ascending, with each dynamic stopwatch having a time zero calibrated to a different burial date, such that there is a disparate presentation to the user.

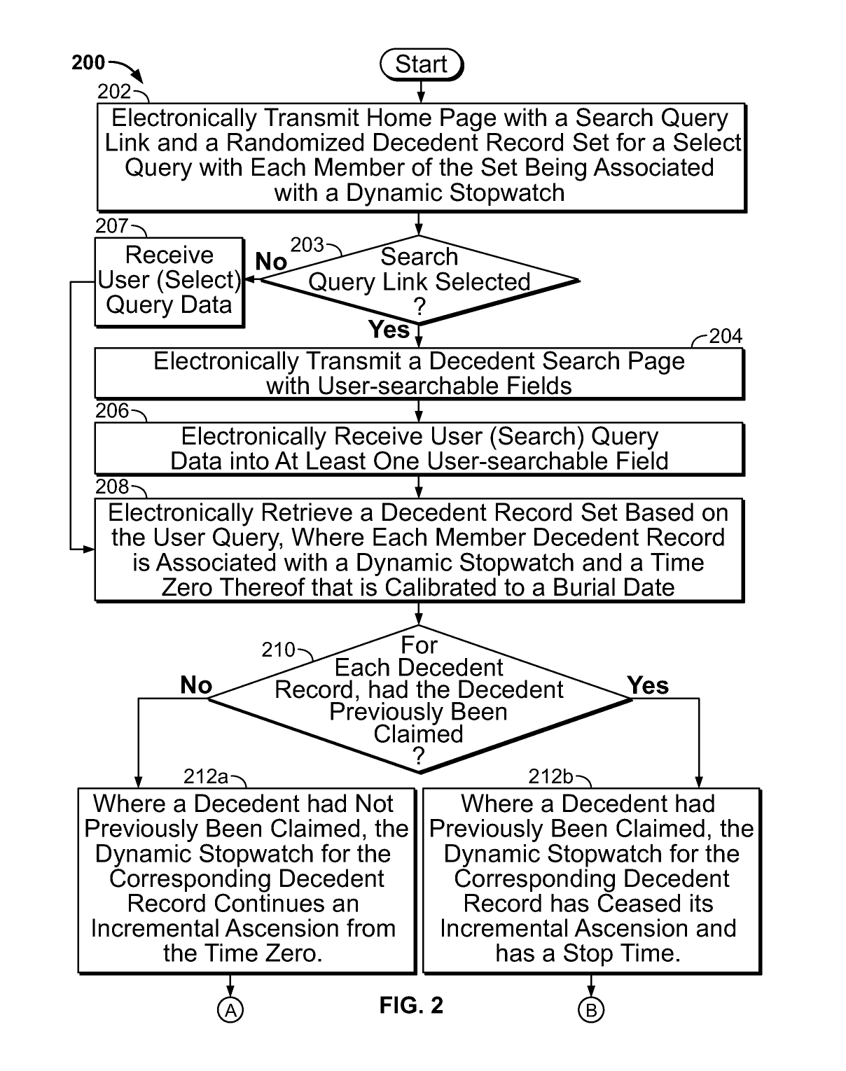

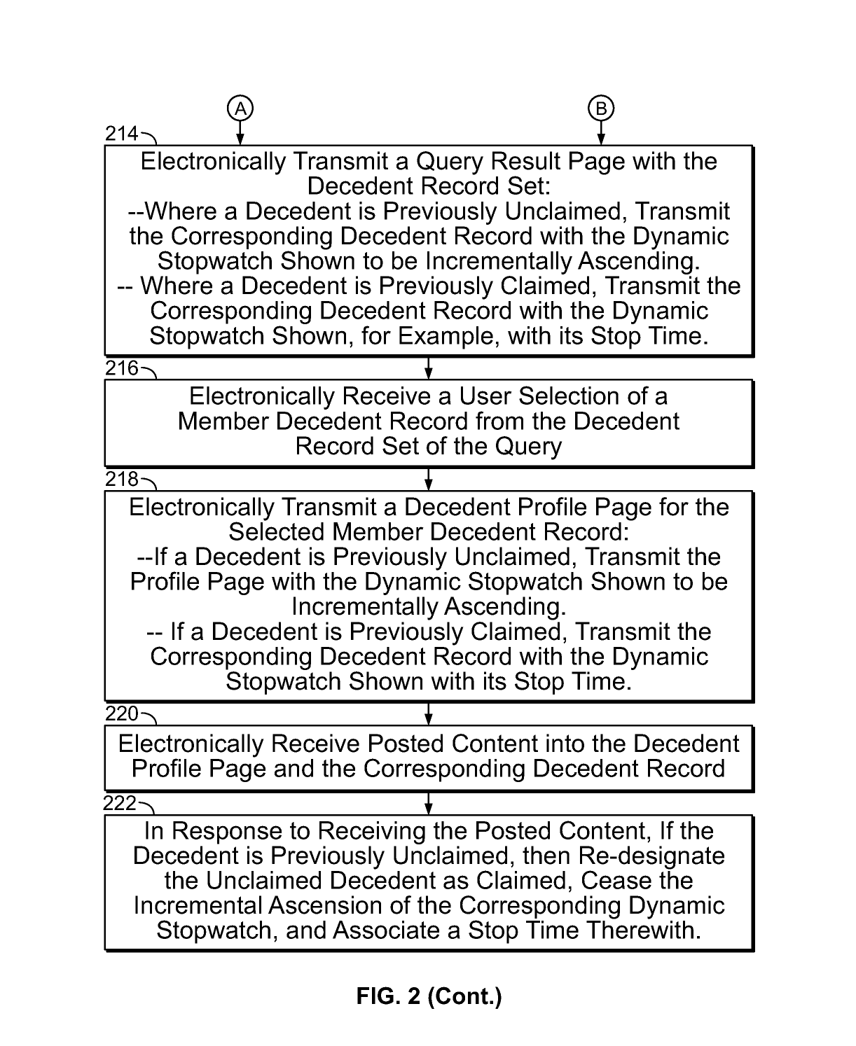

Referring to FIG. 2, a flow chart shows an exemplary method 200 of the present disclosure and shall be herein described.

Preliminarily, it is noted that in exemplary embodiments of the present disclosure, the database 106 may initially be populated by a database administrator, for example. These may include a decedent name field; a decedent place of death field; a decedent year of death field, a decedent burial location field, and field having stored an associated time zero for utilization by the dynamic stopwatch.

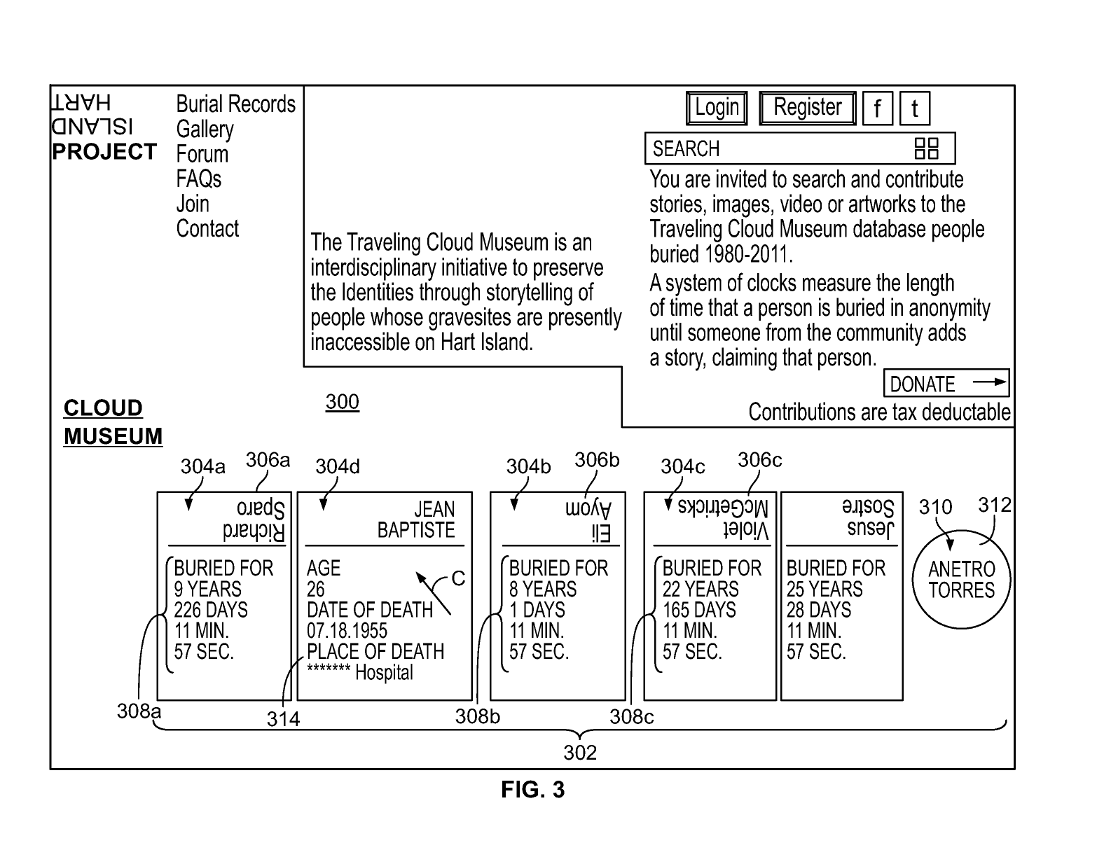

Referring back to FIG. 2, at step 202, the presentation engine 108 electronically transmits a home page with a search query link and a randomized decedent set 302 for a select query, with each member of the set being associated with a dynamic stopwatch. An example home page 300 is shown in FIG. 3, for example. The home page 300 initially includes decedent record set 302. In the example of FIG. 3, the decedent records of the decedent record set 302 are each calibrated to different time zeros, e.g., different burial dates. In other examples, the decedent record set 302 can be provided with enhanced randomness, such that the randomized decedent record set is one in which the burial dates are disparate, the time of day of each burial date is disparate, and the incremental ascension of the dynamic stopwatch occurs at different amount of alignment with the same absolute point in time. In the example of home page 300, there are six decedent records represented visually, though any suitable number is contemplated. For the five leftmost decedent records shown presented in FIG. 3 with a square shape, which are for unclaimed decedent records, each dynamic stopwatch is visible to the user and increments ascendingly in real-time, including that time when the user can see the dynamic stopwatch and that time when the user cannot see the dynamic stopwatch. For unclaimed decedent record 304d, for example, a cursor C is “rolling over” the presentation of the unclaimed decedent record 304d. During the time when the cursor C is rolling over the unclaimed decedent record 304d, for example, decedent facts that are stored in association with the unclaimed decedent record 304d are visible, including, for example, the decedent age, the decedent date of death, the decedent place of death and/or other examples.

The decedent name associated with each decedent record may be shown inverted (upside down) until such time as posted identifying content has been input into the corresponding decedent record via the profile page, and the dynamic stopwatch ceases its accession. Thus, the decedent name for an unclaimed decedent record may be electronically displayed inverted (as shown for names 306a, 306b, and 306c, for records 304a, 304b, and 304c, for example), while a decedent name for a claimed decedent record may be electronically displayed non-inverted (right-side-up), as shown for decedent name 312 for claimed decedent record 310, for example. This could also include the display of the dynamic stopwatch 308a, 308b, 308c, for each of the respective decedent records 304a, 304b, 304c. A decedent name may also be shown non-inverted for an unclaimed decedent record during that time when cursor C is rolling over the unclaimed decedent record, as shown with respect to decedent record 304d, for example. In such a case, the dynamic stopwatch could be temporarily replaced with decedent information 314 (compiled thus far) of the decedent record 304d.

Continuing with reference to FIG. 3, an example of a claimed decedent record is shown presented with a circle as claimed decedent record 310. The dynamic stopwatch associated with decedent record 310 is not shown to be presented, because the decedent record is a claimed decedent record. The dynamic stopwatch exists in the form of a ceased counter, though it is not shown at the example search page 300, and it has a stop time associated with it that represents a total time unclaimed.

Embodiments of the present disclosure allow users to electronically search the decedent records over a network, in which case claimed decedent records and unclaimed decedent records are presented to the user with a presentation akin to that of the home page 300, except that the decedent record set, rather than being randomized, is in accordance with a user-specified electronic search.

Referring to step 203 of FIG. 2, the decedent management computer system 102 determines whether the search query link has been selected. If not, then in step 207, the decedent management computer system 102 receives user (select) query data. For example, a user could scroll, and/or click on a particular member of the randomized decedent record set, etc. The process would then proceed to step 208, as discussed in more detail below. As another example of user query data (e.g., user select query data or user search query data), a user may enter the decedent name, for example, without choosing from a randomized decedent record set.

If in step 203 of FIG. 2, the decedent management computer system 102 instead determines that a search query link was selected, then the process proceeds to step 204. Referring to Step 204 of FIG. 2, the decedent management computer system 102 electronically transmits a search screen of a graphical user interface to a user to enter a user-searchable query of the database 106. Referring to the top portion of FIG. 4A, the search page 400A is provided with a search box 410, including a decedent name field 412, a decedent year of death field 414, a decedent place of death field 416, and a decedent burial location (e.g., trench number) field 418. There is also facility for searching by adult or child. Although FIG. 4A shows a decedent record set 402A and data 420 (“Grant”), it shall be understood that, prior to entry of such data, preferred embodiments of the search page 400A would typically simply show white space, for example, below the search box 410. Any information can initially be shown on the same page as the search box 410 that is suitable for, and/or consistent with, performance of methods herein described.

Referring to Step 206 of FIG. 2 and FIG. 4A, a user enters data into at least one searchable field of the search page 400A. As shown, the decedent surname “Grant” 420 has been entered into the decedent name field 412, and, as between “Adults” and “Babies,” the option for “Babies” has been selected. The decedent management computer system 102 receives the search query from a user, e.g., the decedent management computer system 102 electronically receives search query data from the user computer system 110 into at least one user searchable field.

Referring to Step 208 of FIG. 2 and FIG. 4A, the identify management computer system 102 electronically transmits to the user computer system 110 for electronic display to the user, a decedent record set 402A that includes at least one decedent record having a dynamic stopwatch that is incrementally ascending, such that, in presenting a visual representation to the user, the dynamic stopwatch is seen by the user to ascendingly increment in real-time.

Continuing with reference to FIG. 4A, the search page 400A is shown in which the user has entered a surname 420, e.g., “Grant,” into the deceased name field 412. A visual representation of the deceased record set 402A is electronically presented, whereby a plurality of decedent records, each associated with the name “Grant,” are visually represented. There are thirty decedent records of which twenty-nine are shown to be for unclaimed decedent records (shown as squares) and one is shown as a claimed decedent record (shown as a circle). The twenty-nine dynamic stopwatches of the twenty-nine unclaimed decedents are shown to be incrementally ascending, each from their respective time zero, except that unclaimed decedent record 404c is, in FIG. 4A, shown with the cursor C rolling over the presentation of unclaimed decedent record 404c, such that an alternative presentation is made. This can include a showing of historical facts stored in association with the unclaimed decedent record 404c.

Regarding the claimed decedent record 406d, a dynamic stopwatch associated therewith exists, except that there is no visual presentation thereof being shown in FIG. 4A because the dynamic stopwatch has ceased its incremental ascension, and the graphical user interface (GUI) is utilized to convey to the user for the claimed decedent record 406d a sense of resolution and harmony.

Continuing with reference to search page 400A, there is a representation of a first decedent record 404a electronically associated (e.g., via a database) with a first decedent name 406a and first dynamic stopwatch 408a, a representation of a second decedent record 404b electronically associated (e.g., via a database) with a second decedent name 406b and second dynamic stopwatch 408b, and a representation of third decedent record 404c electronically associated (e.g., via a database) with a third decedent name 406c and third dynamic stopwatch 408c. Each of the decedents of the first, second, and third decedent records 404a, 404b, and 404c, have not (yet) been electronically associated with posted content and thus, the first, second, and third dynamic stopwatches 408a, 408b, and 408c, each continue to incrementally ascend and this is shown in the presentation sent to the user computer system 110 for display, and records 404a, 404b, and 404c are unclaimed decedent records 404a, 404b, and 404c.

For example, the visual representation is electronically associated with a decedent record 404b for the deceased name 406b “Kim Grant,” shown inverted, and with a dynamic stopwatch 408b, whereby the dynamic time unclaimed of the dynamic stopwatch 408b is 19 years, 226 days, 9 minutes, and 44 seconds at the moment the “screen shot” of FIG. 4A was taken. As the user looks upon the visual representation of the decedent record 404b, the dynamic stopwatch 408b is seen to incrementally ascend (e.g., 45 seconds, 46 seconds, 47 seconds, 48 seconds, etc.). As discussed above, each dynamic stopwatch has a time zero calibrated to the burial date, and, in some embodiments, a randomized time of day thereof. The visual representation of the time unclaimed of a dynamic stopwatch can be in any suitable form. For example, additionally/alternatively to the “tile” visual of the appended drawings, a decedent record set can be provided in table form with a row and/or column showing an incremental ascension of the dynamic stopwatches. Any visual representation for conveying ascension of the dynamic stopwatch is suitable.

Continuing with reference to FIG. 4, another example visual representation of a decedent record 404a is provided in association with the deceased name 406a “”Phyllis Grant,” shown inverted, and a second dynamic stopwatch 408b, whereby the dynamic time unclaimed of the dynamic stopwatch 408a is 24 years, 323 days, 9 minutes, and 44 seconds at the moment the “screen shot” was taken. As the user looks upon the decedent record 404a, the dynamic stopwatch 408a incrementally ascends, and the visual representation of the dynamic stopwatch is displayed to be incrementally ascending (e.g., 45 seconds, 46 seconds, 47 seconds, 48 seconds, etc.).

In the example shown in FIG. 4A, the time zero associated with the decedent record 404a and the time zero associated with the decedent record 404b, while being on different days, are the same time of day, which is why the visual representation of these two decedent records are both shown to be associated with [0 hours,] 9 minutes, and 44 seconds (the zero value of hours being implied by the absence of an hour designation). However, while the time zero of multiple decedent records may be calibrated to the same time of day in some examples of the present disclosure, the time zero could be calibrated to different and/or randomized times of day, as discussed above, so as to enhance the feeling of disparity conveyed to the viewer of the page 400A, as each dynamic stopwatch is seen to incrementally ascend from its time zero. In this regard, the user associates an even further elevated sense of resolution with a decedent record for which the dynamic stopwatch has ceases its ascension. In FIG. 4, a visual representation of a decedent record 404d is shown that has previously been associated with posted content, such as an image, story, or YouTube link, for example. As such, the decedent name 406d (“Laurie Grant”) is shown in with non-inverted text, and the dynamic stopwatch no longer incrementally ascends, and it has been associated with a total time unclaimed.

Referring to FIG. 4B, yet another example of a search page 400B is shown. Here the decedent name 420 (e.g., “Grant”) has been electronically entered into the decedent name field 412 and the decedent year of death 422 (e.g., “1993”) has been entered into the decedent year of death field 414. In this example, the computer system electronically returns a decedent record set 402B including the decedent record 404b associated with a first decedent name 406b (“Kim Grant”), as well as visual representation of the dynamic stopwatch 408b, whereby the dynamic unclaimed time is initially shown to be “19 years, 226 Days, 8 minutes, and 58 seconds,” and which increments ascendingly in real-time while being visually represented to the user (e.g., 8 minutes 59 seconds; 9 minutes 0 seconds; 9 minutes 1 second; etc.).

Continuing with reference to FIGS. 4A and 4B, a visual representation of the decedent record 404d is shown. As discussed above with reference to FIGS. 4A and 4B, the decedent record 404b is associated with a dynamic stopwatch that has ceased its ascension, such that the time unclaimed is no longer a dynamic time unclaimed, but it is a total time unclaimed. The decedent record 404d has been electronically associated with posted content and thus “the clock has stopped ticking.” The decedent name 406d associated with the decedent record 404d (Laurie Grant) is thus shown to be non-inverted, and a visual representation of the dynamic stopwatch for decedent record 404d is not presented at search pages 400A and 400B. The side-by-side contrast between the visual representation of the ascending dynamic clock 408b and the absence of a visually represented dynamic clock for decedent record 404d highlights the absence of resolution that a user of the system might feel in connection with decedent record 404b.

Accordingly, referring to Steps 208, 210, 212a-b, and 214 of FIG. 2, it can be seen that the presentation engine 108 electronically retrieves a decedent record set from the database 106 for presentation thereof to a user computer system 110 with dynamic stopwatches. For example, at step 208, the decedent management system 106 electronically retrieves a decedent record set based on the user search query, where each member of the decedent record is electronically associated with a dynamic stopwatch (even if such dynamic stopwatch is not visually displayed on the search page), and where a time zero of each dynamic stopwatch is calibrated to burial date. At step 210, just prior to display of the search page, for example, the presentation engine 108 of the decedent management system 104 identifies whether each decedent record set is either a claimed decedent record or an unclaimed decedent record. At step 212a, for an unclaimed decedent record, where a decedent had not previously been claimed (e.g., no posted content or an otherwise insufficient amount of posted content), the dynamic stopwatch electronically associated therewith continues its incremental ascension from the corresponding time zero. At step 212b, for a claimed decedent record, where a decedent has previously been claimed (e.g., any posted content or an otherwise sufficient amount of posted content), the dynamic stopwatch for the corresponding decedent record has ceased its incremental ascension and has a stop time for a total time unclaimed. At step 214, the search results are electronically displayed over a network at the search page with the decedent record set. At step 214, where a decedent record is a previously unclaimed decedent record (insufficient posted content), e.g., the decedent record is presented for display with the dynamic stopwatch shown to be incrementing ascendingly (and, optionally, with the decedent name shown inverted). At step 214, where a decedent record is a previously claimed decedent record (e.g., sufficient posted content), e.g., the decedent record could be presented for electronic display with the dynamic stopwatch shown to have its incremental ascension ceased, or, as shown in the examples of FIGS. 4A and 4B, the dynamic stopwatch may optionally not be shown, though it still exists, albeit, with its ascension ceased.

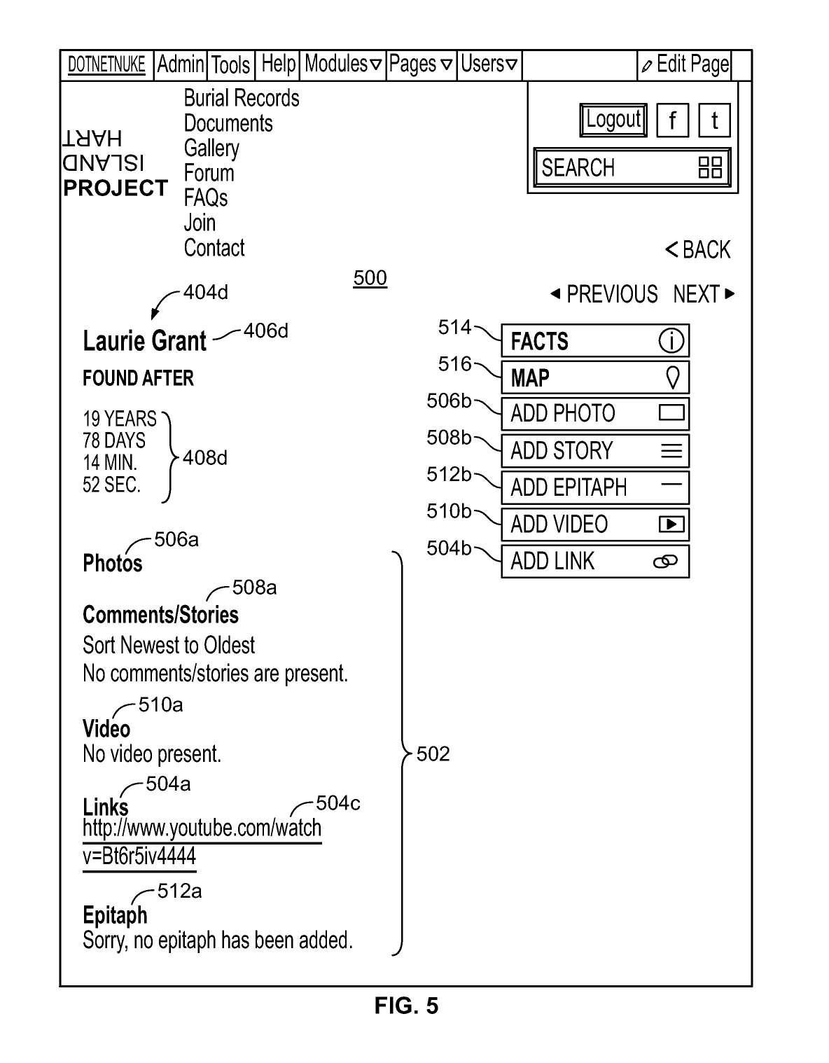

A user can use cursor C to select one of the decedent records by clicking to select the desired decedent record. If the selected decedent record set is a claimed decedent record (such as Laurie Grant), then the user may be taken to a profile page, such as that shown and described in connection with FIG. 5 with posted content (YouTube link 504a) and a dynamic stopwatch 408b with its incremental ascension having been ceased. In contrast, if the selected decedent record is an unclaimed record set (such as that of Kim Grant, for example), then a similarly formatted profile page would be displayed, except that the contents of the page would correspond to Kim Grant. For example, a dynamic stopwatch would be visually shown to be incrementing in real-time on the corresponding profile page and no content (i.e., no YouTube link 504a) would be shown.

Referring to FIG. 2, the method proceeds from step 206 to step 208, whereat the decedent management computer system 102 receives a user selection from a user computer system 110 over the network 100.

At step 218, decedent management computer system 102 electronically transmits to the user computer system 110 a decedent profile page (for display to the user thereof) with a visual representation of the associated dynamic stopwatch.

In some embodiments of the present disclosure, a profile page is where users of a user computer system can electronically input information (e.g., via a graphical user interface) to be electronically posted in association with the corresponding decedent record. In some embodiments, the user is a registered user (e.g., a user that has provided their own name and other information to the system administrator). At the profile page, similar to Wikipedia or other “Wiki-” sites, a user can post relevant information, such as stories, videos, images, epitaphs, and other information associated with the decedent.

In the improvement of the present disclosure, which relates to the dynamic stopwatch feature, a profile page electronically associated with a decedent record can be provided so as to include a visual representation of the dynamic stopwatch. Where the dynamic stopwatch has ceased ascending, e.g., where there has been a stop time, the visual representation of the dynamic stopwatch within the profile page is shown to be static. Where the dynamic stopwatch continues its ascension, e.g., where there has (not yet) been a stop time, then the visual representation of the dynamic stopwatch within the profile page is shown to be dynamic, e.g., shown to be incrementally ascending.

Referring to FIG. 5, an example profile page 500 is shown for the decedent record 404d in association with a decedent name 406d (Laurie Grant) and a dynamic stopwatch 408d thereof. As discussed above, a visual representation of the dynamic stopwatch 408d was not shown at search pages 400A and/or 400B, because the dynamic stopwatch 408d had previously ceased incrementing. More specifically, at a point where the total time anonymous was 19 years, 78 days, 14 minutes, and 52 seconds, a user had electronically entered posted content 502 into the profile page 500, thereby “stopping the clock” and imparting a sense of personality to Laurie Grant. More specifically, in the example of FIG. 5, the posted content was provided as a YouTube link 504c input by a user as posted content in the link field 504a. As opposed to posted content, such as photos 506a, comments/stories 508a, a video 510a, and/or an epitaph 512a, which the user could have posted using the user computer system 110, the example of FIG. 5 shows a user who provided posted content in the form of supplemental content of a third party content provider system 112 (e.g., YouTube servers). The user can electronically input additional posted contents into the other fields if so desired.

Continuing with discussion of the example profile page 500 of FIG. 5, an add photo button 506b can be activated to electronically post a photo to the photo field 506a, an add story button 508b can be activate to electronically post a story or other narrative to the comments/stories field 508a, an add epitaph button 512b can be activated to electronically post an epitaph to the epitaph field 512a, an add video button 510b can be activated to electronically post a video to the video field 510a, and an add link button 504b can be activated to electronically post supplemental content, e.g., a link, to the links field 504a. The posted content is saved in association with decedent records in the database 106. A facts button 514 may be activated to display all fields in the database of facts about the deceased person.

A map button 516 can be activated to a light box showing a location of the plot/trench on Hart Island with all the features of the third party Google maps application, namely, a map or aerial image, with the decedent record 326a from third party content provider computer system 112, e.g., servers hosting Google maps. GPS information will be associated with Trench/Plot location in The Hart Island Project database 106 and is not otherwise available to for public view. For example, whereas FIG. 8 shows a profile page associated with a decedent (e.g., Vanessa Rodriquez) and having a maps button, FIG. 9 shows a map of the corresponding burial community (e.g., Hart Island) and the location at the burial community where the decedent is buried. An overlay of a current Google satellite photo/map of Hart Island is provided for example. GPS information can provide an image of a specific trench/plot location on the Google map where that person is buried, for example. The decedent record can include GPS plot location information (e.g., longitude and latitude) that linked to third party mapping tools such that where a third party content provider has taken an image, e.g., aerial image, of the burial location, such supplemental information will be provided with the decedent record by virtue of a link to the third party provider.

Continuing with reference to the example of FIG. 5, it can be seen that posted content was input from a user computer system 110 to the decedent management system 102 and saved with the decedent record 404d in the database 106. In accordance with the improvement of the present disclosure (the dynamic stopwatch feature), a visual representation of the dynamic stopwatch is provided for display with the profile page 500, and the association of the posted content (the URL link 504a) has “stopped the clock,” such that the unclaimed time is no longer dynamic, but is shown as a total unclaimed time (that no longer ascends).

In an example of the present disclosure, such as with decedent record 404b of FIG. 4B (Kim Grant), for example, the dynamic stopwatch is continuing its incremental ascension, and the profile page associated with this decedent record (e.g., the profile page associated with the record of Kim Grant) would have the dynamic stopwatch shown to be incrementally ascending with the decedent name inverted. Thus, when a user of a user computer system 110 clicks on the visual representation of decedent record 404b shown at FIG. 4B, for example, the decedent management computer system 102 transmits a profile page associated with the decedent record 404b (not shown) to the user computer system 110 for display to the user. In some embodiments of the present disclosure, the profile page of decedent record 404b would include no posted content (or, in some embodiments, an otherwise insufficient amount of posted content) to trigger cessation of the incrementing ascension of the dynamic stopwatch. The profile page of decedent record 404b includes a visual representation of the dynamic stopwatch, which can be shown at the profile page to be ascending.

Thus, referring to step 216 of FIG. 2, after the search result page was presented at step 214, the user selects at step 216 a member of the decedent record set shown at the search page, and the method proceeds from step 216 to step 218, discussed above, where a profile page is displayed.

It shall also be appreciated by one skilled in the art that, where a randomized decedent record set had been presented at the home page at step 202, a user may select a decedent record set from the home page, so as to proceed from step 202 to viewing a profile page in accordance with step 218, as described below.

At step 218 of FIG. 2, the decedent management system 102 electronically transmits for display to the user computer system 110 a decedent profile page for the selected member decedent record. At step 218, if the user-selected record is a previously unclaimed decedent record, the profile page is shown with the dynamic stopwatch incrementally ascending and the decedent name inverted. At step 218, if the user-selected record is a previously claimed decedent record, the profile page is shown with the dynamic stopwatch ceased (e.g., the stop time or total time unclaimed is shown), and the decedent name is shown inverted.

Referring to step 220 of FIG. 2, decedent management computer system 102 receives from user computer system 110 information that is posted content for the profile page associated with decedent record. At step 222 of FIG. 2, the decedent management computer system 102, the decedent management system saves the posted content in association with the decedent record. The decedent management system 102 identified if the decedent record was previously designated as an unclaimed decedent record, and, if it was, it re-designated the record as a claimed decedent record, thereby ceasing the incremental ascension of the dynamic stopwatch associated therewith.

Thus, having been designated as a claimed decedent record, where a decedent record is subsequently retrieved in a search and/or where the profile page associated with a decedent record is presented, the visual representation of the dynamic stopwatch in the profile page will be shown to be static (like that of Laurie Grant in FIG. 5), and the visual representation of the dynamic stopwatch in the search page will be absent (like that of Laurie Grant in FIGS. 4A and 4B).

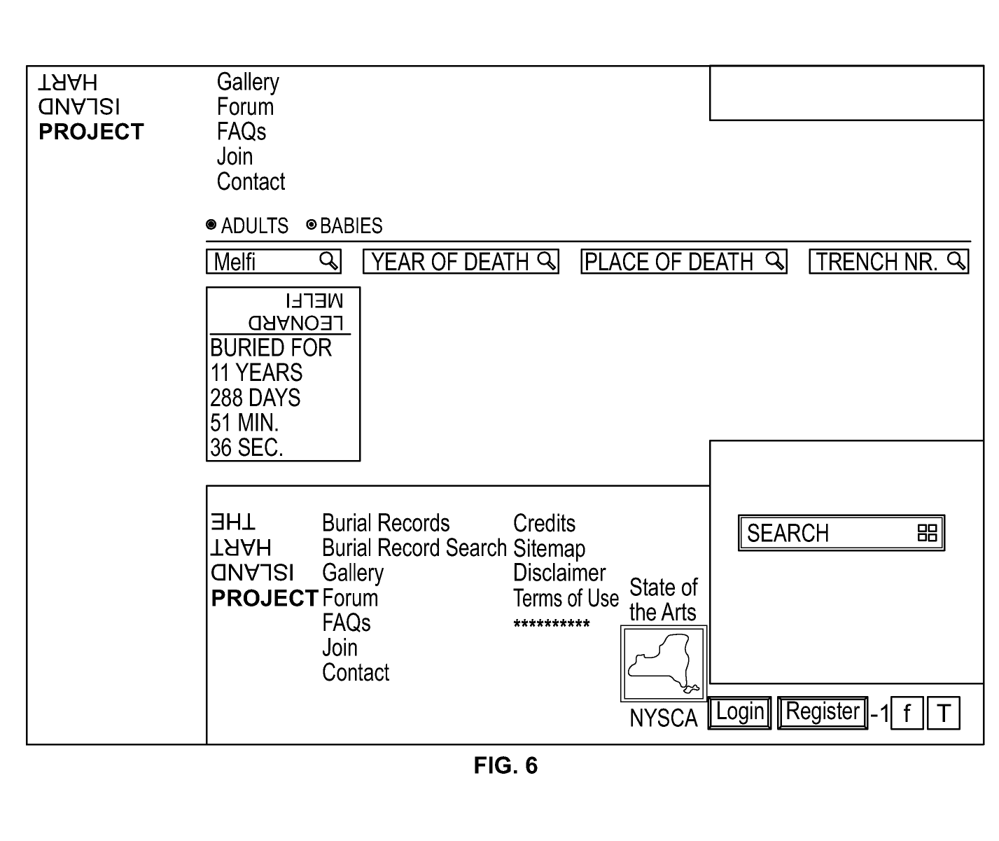

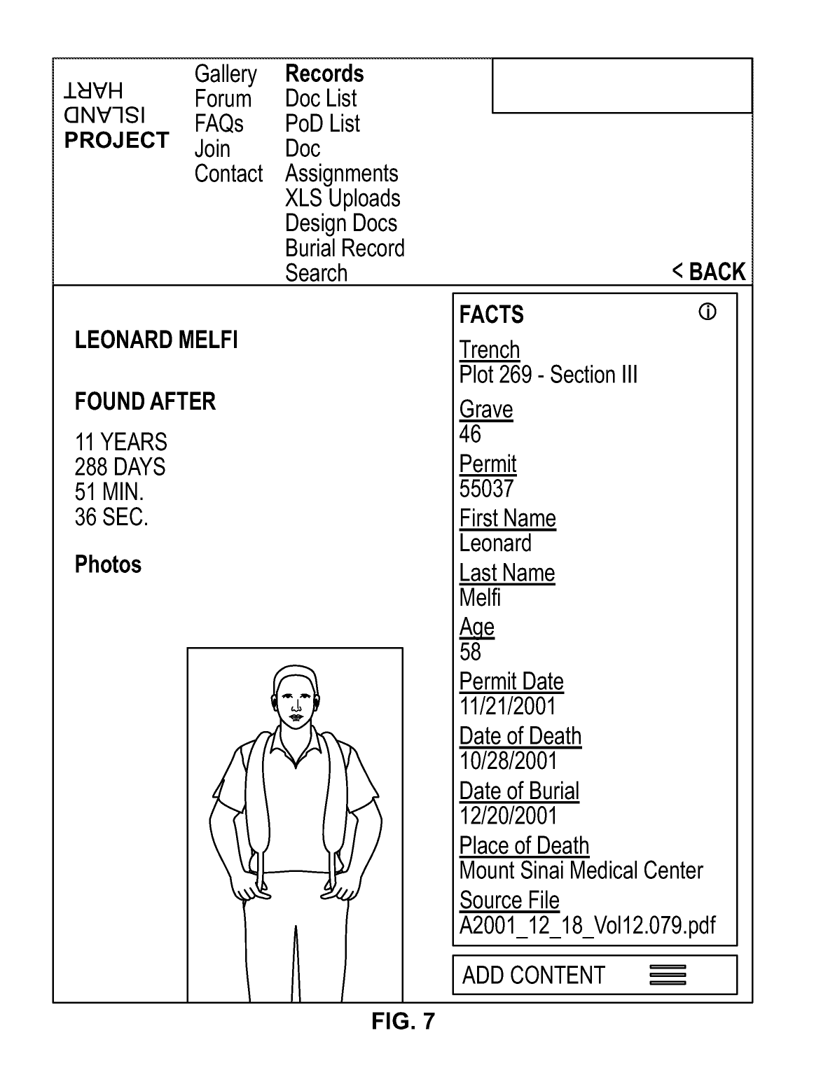

Referring to FIGS. 6 and 7, another example search page and profile page are shown. Referring to FIG. 6, a search has been conducted for the name “Melfi” (and “Adults”) and a decedent record therefor has been returned. In FIG. 6, the decedent record is an unclaimed decedent record, as designated by a presentation of the dynamic stopwatch that is shown in FIG. 6 to be incrementally ascending (e.g., . . . 36 seconds, . . . 37 seconds, . . . 38 seconds) and as designated by a presentation of the decedent name in inverted form.

Should a user click to electronically select the presentation of the decedent record for Mr. Melfi of FIG. 5, they would be brought to a profile page having an absence of posted content (page not shown). Such a profile page may have facts associated with Mr. Melfi taken from the historical record, for example. However, because member(s) of the public have not yet entered any posted content into the fields therefor, the unclaimed decedent record continues to be designated as an unclaimed decedent record.

Once the public has input posted content into the profile page, such as in accordance with the profile page as it is shown in FIG. 7, where the public has uploading a drawing into the photography field, then, as shown in FIG. 7, the dynamic clock ceases its incremental ascension, and the record, previously designated as an unclaimed decedent record, is re-designated by the decedent management system 102 as a claimed decedent record.

Preferred embodiments of the dynamic stopwatch of the present disclosure can be utilized as an improvement to, for example, the prior art online database of the Hart Island Project described above in the Background of the Invention. As discussed above in connection with the Hart Island Project of the Background of the Invention, the dead are lost through the burial process, and the public has limited accessibility to Hart Island. However, the dynamic stopwatch features of the present disclosure help to bring the stories of the buried to life by activating the records of their burial, for example. A period of time is assigned to the duration that each person remains anonymous within a mass gravesite. The stories of the deceased become “alive” when visitors add information about individual people such that they are no longer an anonymous number in a database. An advantage is to create an enticing platform where the public can find their buried loved ones. A burial time is implemented for each decedent using data to measure how long each person's identity has been hidden through the institutional burial practice used on Hart Island. Visually speaking, the burial time can be represented as clocks assigned to deceased persons, e.g., a dynamic stopwatch. Each clock can show hours, minutes and seconds digitally and up-to-date at a randomly assigned time as measured from the actual calendar day listed in the historical record (e.g., ledger books) documenting that the decedent was buried. Burial records in the prior art are organized with a source code that indicates the date of burial listed at the top of each numbered page from the ledger books pages provided by the DOC. Since witnesses to the burials are limited to inmates and correction offices, the exact moment of burial is unlisted on the ledger books pages and therefore unknown. Thus, in some embodiments of the present invention, a digital clock starts ticking from the day the person was buried with a randomized time of day. The clock, e.g., dynamic stopwatch, will indicate how long each decedent has been forgotten to time. At the moment (or shortly thereafter) that a narrative, image, or other posted identifying content is added to the database, the ticking clock, the time of forgetfulness, will stop. This moment will represent an opening of this person's history to the world. The digital clock, which may be provided together with an inverted name of the decedent, will then convert to become the name of the decedent in non-inverted form when their anonymity ends.

In some embodiments of the present disclosure, a web site incorporating the dynamic stopwatches of the present invention can be provided in association with the Hart Island Project.

For example, referring to a new visitor with little knowledge about The Hart Island Project, the visitor enters an environment reminiscent of a museum feel. Through the inverted-text logo of The Hart Island Project and the quotes the context will become clear to the visitor. The visitor will visually compare anonymity vs. identity because of certain names that are also visible. When the visitor rolls over a clock the name of the decedent associated with that clock appears inverted. The visitor may then click on that particular clock and enter a profile page with the prior art facts about the person buried appearing. The person's information (database facts) becomes visible and the visitor is presented with the option of adding information about that decedent. At this moment, for example, the visitor will realize that every clock represents a person buried on Hart Island. The visitor thus engaged on the search page rolls over another ticking clock and another inverted name appears. The visitor may simultaneous see a name instead of a ticking clock. Now the visitor will click to open a profile page with any or all pictures, poems and stories added to that point in time as well as the stopped watch indicating when the period of anonymity ended and that decedent became known. The visitor will then have the option of adding more information and also get the idea that by adding content the people will regain their identity. They lose their anonymity. They have a place in history. To participate through adding as story, image or link the visitor is prompted to register and login with a new account. S/he searches in any of four fields to activate a display of ticking clocks and rolls over any clock to see an inverted name of a person s/he has affinity with. S/he enters the profile page to add fictional or nonfictional stories, poems, images, and links. This action stops the clock in the database and the (non-inverted) name of the person becomes visible. The homepage displays random samples of decedents in the database, claimed and unclaimed with clocks of anonymity either ticking or stopped.

As another example, referring to a returning visitor that has a relative or friend buried on Hart Island, the visitor begins by entering the home page. The visitor is familiar with the ticking clock and the structure of the website. The visitor wants to search for a relative buried on Hart Island. At the homepage the visitor has the option to access the search page for this person. The visitor clicks the search button to view the search page and then searches by name, and/or date of death, and/or location (plot/trench) and/or place of death. A structured list of results with the ticking clocks visible and names of claimed identities will appear so the visitor can locate the person if they are included as a decedent in the database. All the database facts of this person will become visible on the profile page in the list. The visitor rolls over any ticking clock or named person in the search results and clicks to enter the decedent's profile page where all the facts or stories or burial location map pertaining to the individual becomes visible. The visitor then registers and logs in. The visitor already logged in starts adding pictures and poems to stop the clock of anonymity for this person and make their name visible, no longer inverted in an anonymous state.

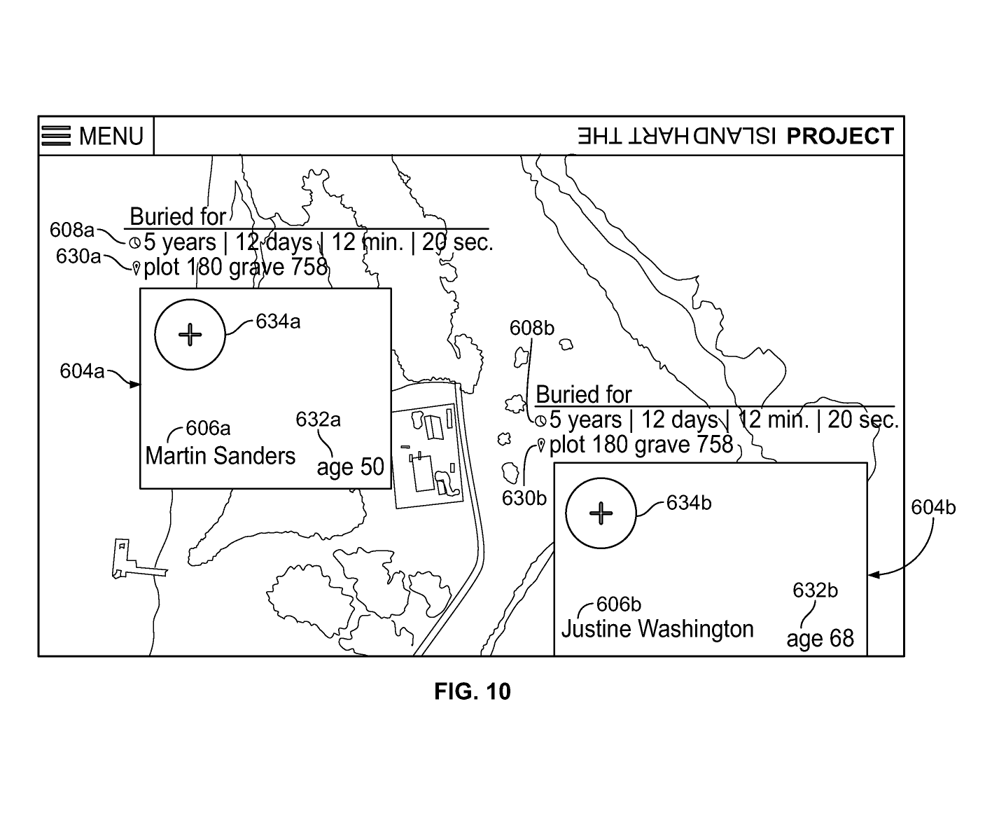

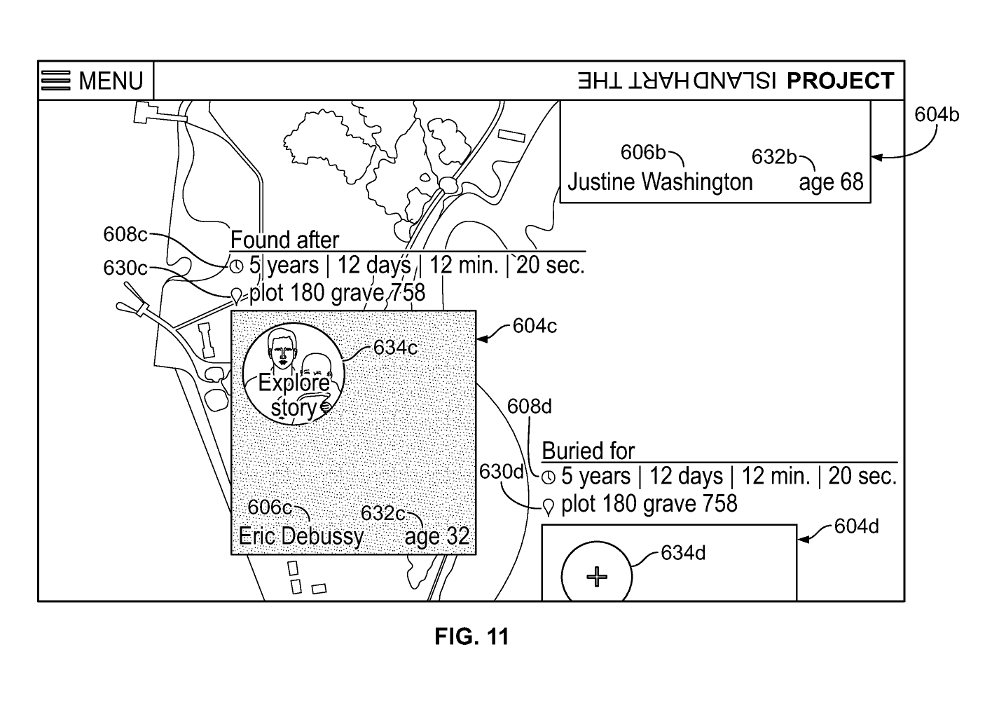

FIG. 10 is a screen shot showing an exemplary home page of another embodiment, the home page shown with a decedent record set (e.g., randomized decedent record set) that includes a plurality of decedent records each having a dynamic stopwatch. FIG. 11 is a screen shot showing another view of the exemplary home page of FIG. 10.

More specifically, shown is a home page with a first decedent record 604a having a first decedent name 606a, a first decedent age 632a, a first dynamic stopwatch 608a, a first burial information 630a, and a first information button 634a. Similarly, the home page also includes a second decedent record 604b (having a second decedent name 606b, a second decedent age 632b, a second dynamic stopwatch 608b, a second burial information 630b, and a second information button 634b), a third decedent record 604c (having a third decedent name 606c, a third decedent age 632c, a third dynamic stopwatch 608c, a third burial information 630c, and a third information button 634c), and a fourth decedent record 604d (having a fourth decedent name (not shown), a fourth decedent age (not shown), a fourth dynamic stopwatch 608d, a fourth burial information 630d, and a fourth information button 634d). Of course more or less information could be shown on the home page for each decedent record.

When a user visits the home page, a decedent record set, including a plurality of decedent records as described above, is transmitted by the system to the user. The plurality of decedent records could be randomized (e.g., independent of user input) or could be partly randomized (e.g., dependent on user input). For example, the home page could include a map area of where a plurality of decedents are buried. When a user scrolls a mouse over a particular area of the map area, the system could transmit one or more decedent records which are buried in the particular map area the user has scrolled over. Alternatively (or additionally), the plurality of decedent records could move onto and off of (e.g., from bottom to top) a display (e.g., computer screen) of a user, where the movement could be done automatically by the computer system, or manually by user input (e.g., as the user scrolls down the home page). In either situation, the user could click on a particular decedent record to submit query data (e.g., select query data), to obtain more information on and/or add more information to the selected decedent record.

When selected by the user, the more information button 634a, 634b, 634c, 634d, provided for each decedent record, allows the user to view any information previously entered for that decedent record (e.g., by another user), and/or allows the user to enter any information (e.g., videos, pictures, etc.) the user may have regarding the particular decedent record. An unclaimed decedent record (e.g., decedent records 604a, 604b, 604c) could be aesthetically different than a claimed decedent record (e.g., decedent record 604b). For example, an unclaimed decedent record could be greyed and/or have a generic symbol for the information button. Comparatively, a claimed decedent record could be highlighted (e.g., yellow) and/or have a at least a portion of a photo (e.g., uploaded for that decedent record) for the information button.

In some embodiments, the following can be provided in connection with the dynamic stopwatches of the present disclosure.

### Home Page/Clocks

In some embodiments, each person's file (profile) in the database could have a clock attached to their record.
In some embodiments, this clock could start ticking from on the date of burial for this person.
In some embodiments, the date of burial could be stored in the database and represented in the source code electronically associated with each decedent's record of burial.
In some embodiments, this date can be in days only, and the clock could start at a random time for each date of burial, such that all clocks do not register the exact same time of day. The moment of burial is unknown and therefore is random.
In some embodiments, a random sample of seven clocks ticking in real time representing anonymous decedents in the database as well as claimed identities could appear on the homepage and could be ticking in real time.
In some embodiments, the search page can display a lot of ticking clocks depending on the search criteria entered by the home page visitor (e.g., user).
In some embodiments, a random selection of clocks could appear differently with each visit to the homepage.
In some embodiments, the clocks can be displayed in hours, minutes, seconds, such as 14:45:21 for 2:45 PM.
In some embodiments, the hours in the clock can count up endlessly until the stop time. For example, after one year a clock can be displayed as 8760:00:00 hours.
In some embodiments, when a visitor (e.g., registered user) adds content to a profile in the database the clock could stop ticking and convert to a person's non-inverted text name listed in the database.
In some embodiments, the clock will stop on the exact day and time when this happens. This is displayed in the database as a measure of how long that person was anonymous.
In some embodiments, if somebody adds content, the name of that person could then appear in non-inverted format on the search page and their details could appear in their profile which is accessed by rolling over and clicking the name.
In some embodiments, decedents who are unidentified by name could be listed in the database as “unknown” and can be searched by gender and race in lieu of first and other names, as well as place of death locations, plot/trench, and date of death. These decedents can have their names added when they are identified and/or disinterred and a Hart Island Project administrator is notified.

### Search Results

In some embodiments, the clocks can be provided as part of the database records. If a visitor searches for a decedent, the clocks could appear in the result list, ticking or stopped.
In some embodiments, the person/file (profile) in the database with narrative, image or video content attached can randomly appear on the homepage and/or in the search results.
In some embodiments, the database could be expandable with additional search fields. For example, additional search fields can include location of death, for example and date of death and burial location
In some embodiments, the decedent search result can be ordered according to single or mixed search field criteria including, name, date of death, place of death, place of burial (plot/trench).

### Profile Page

In some embodiments, the clocks could also appear on the profile page.
In some embodiments, users add content on this page like text, links, images and linked videos. Off-the-shelf modules used for directing people to YouTube or Vimeo to add video content.
In some embodiments, if multiple images are uploaded at once they can appear in a gallery.
In some embodiments, content may be ordered chronologically.
In some embodiments, content can be added at each post.

It will be understood that the embodiments of the present invention described herein are merely exemplary and that a person skilled in the art may make many variations and modifications without departing from the spirit and scope of the invention. All such variations and modifications, including those discussed above, are intended to be included within the scope of the invention.

What is claimed is:

1. A method of managing decedents, the method comprising:
electronically receiving at a decedent management computer system from a user computer system a decedent query;
electronically searching a database of the decedent management computer system for an electronic decedent record set corresponding to the decedent query and that has a plurality of electronic decedent records, the plurality of electronic decedent records including a first electronic decedent record with a first decedent burial date and a first electronic dynamic stopwatch having a first time zero calibrated to the first decedent burial date and further including a second electronic decedent record with a second decedent burial date and a second electronic dynamic stopwatch having a second time zero calibrated to the second decedent burial date; and
electronically transmitting, by the decedent management computer system to the user computer system, the electronic decedent record set for displaying at least a portion thereof with at least one of the first electronic dynamic stopwatch and the second electronic dynamic stopwatch shown to be incrementally ascending from the respective one of the first and second time zeros.

2. The method of claim 1, wherein the first electronic decedent record is an unclaimed electronic decedent record.

3. The method of claim 1, wherein the electronic decedent record set includes a burial date for display via a user computer system.

4. The method of claim 2, wherein said sending comprises sending to the user computer system the electronic decedent record set for display thereof with the first electronic dynamic stopwatch shown at a search page to be incrementally ascending from the first time zero.

5. The method of claim 3, wherein the second electronic decedent record is a claimed electronic decedent record.

6. The method of claim 4, wherein said sending comprises sending to the user computer system the electronic decedent record set for display thereof with the second electronic dynamic stopwatch not being shown on the search page.

7. The method of claim 4, wherein the first electronic decedent record is associated with a first decedent name, and the second electronic decedent record is associated with a second decedent name.

8. The method of claim 6, wherein said sending comprises transmitting to the user computer system over a network the electronic decedent record set for display thereof with the first decedent name being shown inverted.

9. The method of claim 7, wherein said transmitting comprises transmitting to the user computer system the electronic decedent record set for display thereof with the second decedent name not being shown to be inverted.

10. The method of claim 4, where a claimed electronic decedent record has received digital posted content.

11. The method of claim 9, where an unclaimed electronic decedent record has not received sufficient digital posted content.

12. The method of claim 1, wherein the decedent query is a decedent search query.

13. The method of claim 1, wherein the decedent query is a decedent select query.

14. A method of managing decedents, the method comprising:
electronically receiving at a decedent management system from a user computer system a decedent query;
electronically searching a database of the decedent management system for an electronic decedent record set corresponding to the decedent query and that has a plurality of electronic decedent records, the plurality of electronic decedent records including a first electronic decedent record with a first decedent burial date and a first electronic dynamic stopwatch having a first time zero calibrated to the first decedent burial date and further including a second electronic decedent record with a second decedent burial date and a second electronic dynamic stopwatch having a second time zero calibrated to the second decedent burial date;
transmitting by the decedent management system to the user computer system over a network the electronic decedent record set for display thereof with at least one of the first and second electronic dynamic stopwatches shown to be incrementally ascending from its respective one of the first and second time zeros;
electronically receiving from the user computer system a user selection of one of the first electronic decedent record and the second electronic decedent record;
electronically transmitting by the decedent management computer system for display at the user computer system a profile page electronically associated with the corresponding selected one of the first electronic decedent record and the second electronic decedent record; and
electronically receiving over the network digital posted content into the profile page from the user computer system for stored association with the corresponding one of the first electronic decedent record and the second electronic decedent record and, if said corresponding one was previously designated as an unclaimed electronic decedent record, then re-designating said corresponding one as a claimed electronic decedent record.
